(19) United States
(12) Patent Application Publication
(10) Pub. No.: US 2020/0029342 A1
(43) Pub. Date: Jan. 23, 2020

(54) Data Transmission Method and Device

(71) Applicant: Huawei Technologies Co., Ltd., Shenzhen (CN)

(72) Inventors: Yue Jiang, Shanghai (CN); Chongde Huang, Shanghai (CN); Youtuan Zhu, Shanghai (CN); Hongjie Hu, Shanghai (CN)

(21) Appl. No.: 16/586,069

(22) Filed: Sep. 27, 2019

Related U.S. Application Data
(63) Continuation of application No. PCT/CN2017/080900, filed on Apr. 18, 2017.

(51) Int. Cl. H04W 72/10; H04W 72/04

(52) U.S. Cl. CPC H04W 72/10; H04W 72/0406

(57) ABSTRACT

Embodiments of the present invention provide a data transmission method and device. The method includes: when a resource position of a first data packet is preempted, generating, by a first device, first indication information, where the first indication information is used to indicate information about the preempted resource position of the first data packet; and sending, by the first device, the first indication information to a second device, so that the second device receives the first data packet based on the first indication information.

### CROSS-REFERENCE TO RELATED APPLICATIONS

This application is a continuation of International Application No. PCT/CN2017/08090000, filed on Apr. 18, 2017, the disclosure of which is hereby incorporated by reference in its entirety.

### TECHNICAL FIELD

Embodiments of the present invention relate to the communications field, and more specifically, to a data transmission method and device.

### BACKGROUND

The international telecommunication union (ITU) defines three broad categories of services under 5G expectation and requirements. The three broad categories of services are an enhanced mobile broadband service (eMBB), ultra low latency and ultra-reliable machine type communications (uMTC), and massive machine type communications (mMTC).

The eMBB service has a low latency requirement. To pursue spectral efficiency, a large amount of calculation exists in scheduling and consumes a relatively long time. When data arrives, a particular time may be waited. However, the uMTC service has a high latency requirement, and scheduling consumes a relatively short time. Accordingly, the uMTC service is usually started later than the eMBB, and when data arrives, a resource may be scheduled and allocated without significant waiting.

In a current system, in a cell in which the uMTC and the eMBB coexist, the uMTC uses a reserved air interface resource, and the eMBB cannot use the air interface resource of the uMTC. An activation probability of the uMTC service is low, and reserved resources cannot be used because the resources are idle in most of time. Therefore, in this manner, there is a great waste of air interface resources.

To improve resource utilization in a scenario in which the two services coexist, during uMTC scheduling, a resource that has already been allocated to the eMBB may be preempted in various manners based on requirements. In this way, no resource needs to be reserved, and when the uMTC service is not activated, all resources may be allocated to the eMBB.

Specifically, an example in which an air interface resource is preempted is used. As shown in FIG. 1, an air interface resource is defined as a time domain resource and a frequency domain resource. The air interface resource is divided into subcarriers in frequency domain, and the air interface resource is divided into symbols in time domain. The air interface resource includes frequency domain and time domain division grids. Each grid is a resource element (RE), and indicates a resource of one subcarrier within one symbol time. Each RE can carry particular information. N consecutive symbols constitute one subframe, and the subframe is used as a transmission time interval (TTI). Scheduling and resource allocation are performed once at each TTI. M subcarriers in one TTI together constitute one resource block (RB).

However, in an existing solution, after a resource of the eMBB is preempted by the uMTC, performance of detection performed by a receive end on the eMBB is seriously affected.

### SUMMARY

Embodiments of the present invention provide a data transmission method and device, so that when a resource position of a first data packet is preempted, performance of detection performed by a receive end on the first data packet can be effectively improved.

According to a first aspect, a data transmission method is provided. The method includes: when a resource position of a first data packet is preempted, generating, by a first device, first indication information, where the first indication information is used to indicate information about the preempted resource position of the first data packet. The method also includes sending, by the first device, the first indication information to a second device, so that the second device receives the first data packet based on the first indication information.

In this embodiment of the present invention, the first device feeds back the preempted position to the second device by using the first indication information, so that the second device can discard information on the preempted position by using the information about the preempted position during data detection and HARQ combination, thereby improving performance of detection performed by the second device on the first data packet.

In some possible implementations, the method further includes: determining, by the first device based on information about a preempted resource of the first data packet, a performance parameter of demodulation performed by the second device on the first data packet; determining, by the first device, second indication information based on the demodulation performance parameter, where the second indication information is used to indicate a data type of a second data packet, the second data packet is sent after the first data packet, and data of the first data packet is the same as data of the second data packet; and sending, by the first device, the second data packet to the second device, where the second data packet includes the second indication information.

In this embodiment of the present invention, when the resource of the first data packet is preempted by another data packet, the first device can adaptively adjust an HARQ transmission by evaluating a demodulation performance loss caused by the preemption, thereby improving spectral efficiency.

In some possible implementations, the determining, by the first device, second indication information based on the demodulation performance parameter includes: determining, by the first device, the second indication information based on the demodulation performance parameter and a modulation and coding scheme (MCS).

In some possible implementations, the determining, by the first device, the second indication information based on the demodulation performance parameter and a modulation and coding scheme (MCS) includes: if the demodulation performance parameter is greater than a first threshold corresponding to the MCS, determining, by the first device, that the second indication information is used to indicate that the second data packet is new data; if the demodulation performance parameter is less than the first threshold and greater than a second threshold corresponding to the MCS, determining that the second indication information is used to indicate that the second data packet is retransmitted data of the first data packet, and a redundancy version of the second data packet is the same as a redundancy version of the first data packet; or if the demodulation performance parameter is less than the second threshold, determining that the second indication information is used to indicate that the second data packet is the retransmitted data of the first data packet, and the redundancy version of the second data packet is different from the redundancy version of the first data packet.

In this embodiment of the present invention, the first device may feed back the preempted position to the second device, so that the second device can discard the information on the preempted position by using the information about the preempted position during the data detection and the HARQ combination, thereby improving the detection performance of the second device.

In some possible implementations, when the second indication information is used to indicate that the second data packet is the retransmitted data of the first data packet, the method further includes: accumulating a quantity of retransmissions of the first data packet, where the quantity of transmissions is used to determine the first threshold, and the quantity of transmissions of the first data packet is added to the quantity of retransmissions, or the quantity of transmissions of the first data packet is not added to the quantity of retransmissions.

In some possible implementations, the sending, by the first device, the first indication information to a second device includes: sending, by the first device, the first data packet to the second device, where the first data packet includes the first indication information; or sending, by the first device, the first indication information to the second device after sending the first data packet.

In some possible implementations, the first indication information includes at least one of the following information: preempted time-frequency resource position information, information about a bit position preempted before encoding, and information about a bit position preempted after the encoding.

In some possible implementations, when preempted resources of the first data packet are contiguous, the first indication information includes preempted start position information and preempted end position information.

In some possible implementations, the second indication information includes a new data indicator (NDI) and/or a redundancy version (RV).

According to a second aspect, a data transmission method is provided. The method includes: receiving, by a second device, first indication information sent by a first device, where the first indication information includes information about a preempted resource position of a first data packet. The method also includes receiving, by the second device, the first data packet based on the first indication information.

In some possible implementations, the receiving, by the second device, the first data packet based on the first indication information includes: when detecting the first data packet, ignoring, by the second device, data on the preempted resource position of the first data packet based on the first indication information.

In some possible implementations, the method further includes: receiving, by the second device, the second indication information sent by the first device, where the second indication information is used to indicate a data type of a second data packet.

In some possible implementations, the second indication information indicates that the second data packet is retransmitted data of the first data packet, and the receiving, by the second device, the first data packet based on the first indication information includes: when combining the retransmitted data and the first data packet, ignoring, by the second device, information about the data on the preempted resource position of the first data packet based on the first indication information.

In some possible implementations, the first indication information includes at least one of the following information: preempted time-frequency resource position information, information about a bit position preempted before encoding, and information about a bit position preempted after the encoding.

In some possible implementations, when preempted resources of the first data packet are contiguous, the first indication information includes preempted start position information and preempted end position information.

According to a third aspect, a device is provided. The device includes a processing unit, configured to: when a resource position of a first data packet is preempted, generate first indication information, where the first indication information is used to indicate information about the preempted resource position of the first data packet. The device also includes a sending unit, configured to send the first indication information to a second device, so that the second device receives the first data packet based on the first indication information.

According to a fourth aspect, a device is provided. The device includes a processor, configured to: when a resource position of a first data packet is preempted, generate first indication information, where the first indication information is used to indicate information about the preempted resource position of the first data packet. The device also includes a transmitter, configured to send the first indication information to a second device, so that the second device receives the first data packet based on the first indication information.

According to a fifth aspect, a device is provided. The device includes a receiving unit, and the receiving unit is configured to: receive first indication information sent by a first device, where the first indication information includes information about a preempted resource position of a first data packet; and receive the first data packet based on the first indication information.

According to a sixth aspect, a device is provided. The device includes a transceiver, and the transceiver is configured to: receive first indication information sent by a first device, where the first indication information includes information about a preempted resource position of a first data packet; and receive the first data packet based on the first indication information.

According to a seventh aspect, a computer-readable storage medium is provided. The computer-readable storage medium stores a program, and the program enables a first device to perform the method according to any one of the first aspect or the possible implementations of the first aspect.

According to an eighth aspect, a computer-readable storage medium is provided. The computer-readable storage medium stores a program, and the program enables a second device to perform the method according to any one of the second aspect or the possible implementations of the second aspect.

According to a ninth aspect, a computer program product including an instruction is provided. When the computer program product is run on a computer, the computer is enabled to perform the method according to the foregoing aspects.

### BRIEF DESCRIPTION OF THE DRAWINGS

FIG. 1 is a schematic diagram of an air interface resource;

FIG. 2 is a diagram of an example of a network structure according to an embodiment of the present invention;

FIG. 3 is a schematic flowchart of a data transmission method according to an embodiment of the present invention;

FIG. 4 is a diagram of an example of a structure of first indication information according to an embodiment of the present invention;

FIG. 5 is another schematic flowchart of a data transmission method according to an embodiment of the present invention;

FIG. 6 is a schematic block diagram of a first device according to an embodiment of the present invention;

FIG. 7 is another schematic block diagram of a first device according to an embodiment of the present invention;

FIG. 8 is a schematic block diagram of a second device according to an embodiment of the present invention; and

FIG. 9 is another schematic block diagram of a second device according to an embodiment of the present invention.

### DETAILED DESCRIPTION OF ILLUSTRATIVE EMBODIMENTS

The following describes technical solutions in the embodiments of the present invention with reference to the accompanying drawings.

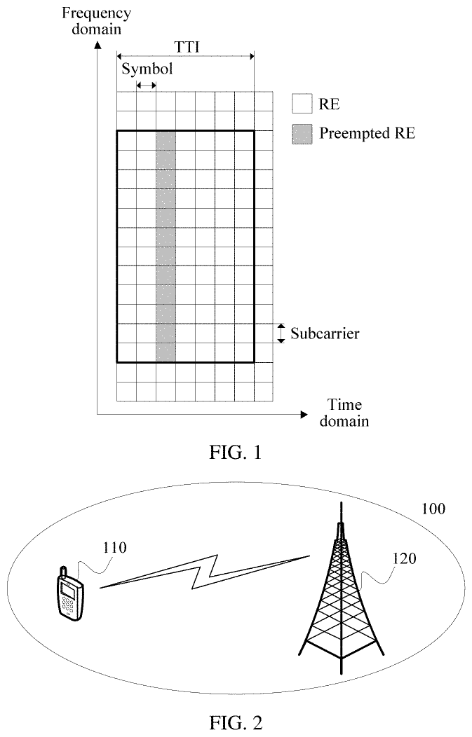

FIG. 2 is a schematic diagram of an application scenario according to an embodiment of the present invention. It should be understood that FIG. 2 is merely an example for description, and examples of the present invention are not limited thereto.

As shown in FIG. 2, a communications system 100 may include a terminal device 110 and a network device 120. The network device 120 may communicate with the terminal device 110 by using an air interface.

The network device 120 sends downlink data to the terminal device 110. The terminal device 110 generates an acknowledgement (ACK) or a negative acknowledgement (NACK) through decoded CRC check, and feeds back the ACK or the NACK to the network device 120. The network device 120 determines, based on the received ACK/NACK, whether to retransmit data or send new data on a same hybrid automatic repeat request (HARQ) process number. The retransmitted data and historical data are combined and detected on the terminal device 110.

For a scenario in which uMTC preempts a resource of eMBB, if a resource corresponding to target data of the eMBB is preempted by target data of the uMTC, the terminal device 110 receives an interference signal rather than a required target signal on a time-frequency resource position. In this case, when the terminal device 110 detects data, demodulation and decoding performance is seriously affected.

In other words, the network device 120 selects, based on only an ACK/NACK fed back by the terminal device 110, to retransmit data. If resources of the eMBB that are preempted by the uMTC make up an excessively large proportion, a data block of eMBB cannot be correctly detected within a quantity of retransmissions. In this way, a plurality of retransmissions obviously reduces system efficiency.

An objective of the embodiments of the present invention is to resolve a problem that HARQ transmission efficiency in a preemptive air interface is not high.

It should be understood that in this embodiment of the present invention, the communications system 100 is merely an example for description, but this embodiment of the present invention is not limited thereto. To be specific, the technical solutions of the embodiments of the present invention can be applied to various communications systems, such as: a global system for mobile communications (GSM), a code division multiple access (CDMA) system, a wideband code division multiple access (WCDMA) system, a general packet radio service (GPRS), a long term evolution (LTE) system, an LTE frequency division duplex (FDD) system, an LTE time division duplex (TDD) system, and a universal mobile telecommunication system (UMTS).

The network device 120 may be an entity that is on a network side and that is configured to send or receive a signal. For example, the network device 120 may be machine type communication (MTC) user equipment, a base transceiver station (BTS) in GSM or CDMA, a NodeB in WCDMA, an evolved NodeB (eNB or eNodeB) in LTE, or a base station device in a 5G network.

In addition, the terminal device 110 may communicate with one or more core networks by using a radio access network (RAN). The terminal device 110 may also be referred to as an access terminal, user equipment (UE), a user unit, a user station, a mobile site, a mobile station, a remote station, a remote terminal, a mobile device, a user terminal, a terminal, a wireless communications device, a user agent, or a user apparatus. For example, the terminal device 110 may be a cellular phone, a cordless phone, a session initiation protocol (SIP) phone, a wireless local loop (WLL) station, a personal digital assistant (PDA), a handheld device or a computing device having a wireless communication function, another processing device connected to a wireless modem, an in-vehicle device, a wearable device, or a terminal device in a future 5G network.

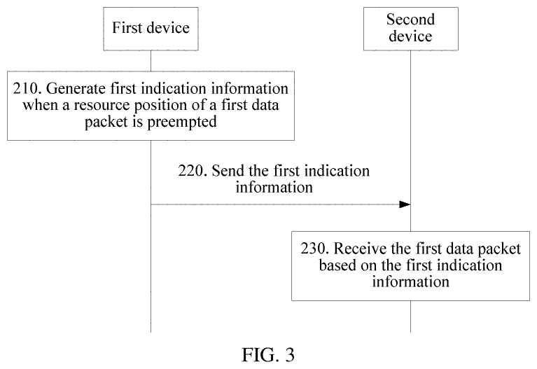

FIG. 3 is a schematic flowchart of a data transmission method 200 according to an embodiment of the present invention.

As shown in FIG. 3, the method 200 includes the following steps.

210: When a resource position of a first data packet is preempted, a first device generates first indication information.

Specifically, when the resource position of the first data packet is preempted by another data packet, a second device (for example a receive end) needs to optimize demodulation and decoding based on information about the preempted position. Therefore, when the resource position of the first data packet is preempted, the first device may generate the first indication information, and the first indication information is used to indicate the information about the preempted resource position of the first data packet.

Optionally, the first indication information in this embodiment of the present invention may include the information about the preempted resource position of the first data packet.

It should be noted that the resource position of the first data packet may be preempted by other data packets in different phases. For example, the resource position of the first data packet is preempted on a modulated symbol (constellation diagram mapping), and the preempted position corresponds to time-frequency resource positions of an air interface, namely, an RE position and an RB position. For another example, the resource position of the first data packet is preempted during a process such as rate matching or interleaving, and the preempted position corresponds to a bit position after encoding. For another example, the resource position of the first data packet is preempted during an encoding process, and the preempted position corresponds to a coded bit position.

To be specific, the first indication information includes at least one of the following information: preempted time-frequency resource position information, information about a bit position preempted before encoding, and information about a bit position preempted after the encoding.

Optionally, when preempted resources of the first data packet are contiguous, the first indication information may include preempted start position information and preempted end position information.

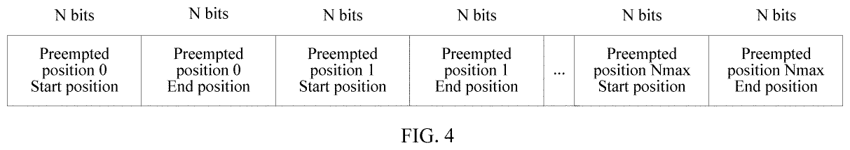

Specifically, as shown in FIG. 4, when the first indication information indicates contiguous preempted resource positions in N bits, only a start position and an end position need to be indicated.

It should be understood that in this embodiment of the present invention, the first indication information may directly carry the information about the preempted resource position of the first data packet, or the information about the preempted resource position of the first data packet may be impliedly indicated to the second device. This is not specifically limited in this embodiment of the present invention.

For example, the first device may establish a correspondence between at least one piece of resource position information and at least one identifier, and send the correspondence to the second device, so that when the resource position of the first data packet is preempted, the first device may directly send an identifier corresponding to the preempted resource position to the second device, and the like.

220: The first device sends the first indication information to the second device.

Specifically, after generating the first indication information, the first device sends the first indication information to the second device.

Optionally, the first device sends the first data packet to the second device, and the first data packet includes the first indication information. Alternatively, the first device sends the first indication information to the second device after sending the first data packet.

Specifically, the first device can generate the first indication information only after the resource position of the first data packet is preempted by another data packet. Therefore, after the first device generates the first indication information, if the first indication information can be carried in the first data packet, the first device may add the first indication information to the first data packet; or if the first indication information cannot be carried in the first data packet, after sending the first data packet, the first device may separately send the first data packet to the second device, or add the first data packet to another data packet and then send the another data packet to the second device.

230: The second device receives the first data packet based on the first indication information.

Specifically, the second device determines the preempted resource position of the first data packet based on the first indication information sent by the first device, and ignores data information on the preempted resource position of the first data packet when detecting or combining the first data packet.

For example, when detecting the first data packet, the second device ignores data on the preempted resource position of the first data packet based on the first indication information. To be specific, if the first device can indicate the preempted resource position in the current transmission, the second device ignores the data information on the corresponding position during the current data detection.

For another example, when the first device sends retransmitted data of the first data packet to the second device by using an HARQ technology, the second device may ignore the data information on the corresponding position during HARQ combination.

To be specific, in this embodiment of the present invention, the first device feeds back the preempted position to the second device by using the first indication information, so that the second device can discard the information on the preempted position during the data detection and the HARQ combination by using the information about the preempted position, thereby improving detection performance of the second device.

It should be understood that, with reference to the accompanying drawings, when the resource of the first data packet is preempted by another data, the first device needs to send the information about the preempted resource position of the first data packet to the second device, so that the second device detects the first data packet based on the first indication information.

In this embodiment of the present invention, to further improve spectral efficiency, optionally, the first device (for example, a transmit end) may adaptively adjust an HARQ transmission policy of a preempted user and indicate the adjusted HARQ transmission policy to the second device (the receive end).

Specifically, the first device determines, based on information about the preempted resource of the first data packet, a performance parameter of demodulation performed by the second device on the first data packet. The first device determines second indication information based on the demodulation performance parameter. The second indication information is used to indicate a data type of a second data packet, the second data packet is sent after the first data packet, and data of the first data packet is the same as data of the second data packet. The first device sends the second data packet to the second device, and the second data packet includes the second indication information.

To be specific, when the resource of the first data packet is preempted by another data packet, the first device adaptively adjusts an HARQ transmission by evaluating a demodulation performance loss caused by the preemption, thereby improving the spectral efficiency.

It should be understood that in this embodiment of the present invention, the data of the second data packet may be the same as the data of the first data packet. In addition, a redundancy version of the second data packet and a redundancy version of the first data packet may be the same or may be different. Redundancy versions correspond to different coded bit subsets, and the subsets include different bits.

In addition, in this embodiment of the present invention, the HARQ technology is used, to be specific, the first device can retransmit a data packet that fails to be transmitted last time. Therefore, the first device needs to indicate, by using the second indication information to the second device, whether the currently transmitted packet is a retransmitted data packet or an initially transmitted data packet.

Optionally, the second device receives the second indication information sent by the first device, and the second indication information is used to indicate the data type of the second data packet. The second device processes the second data packet based on the data type of the second data packet.

For example, if the second indication information indicates that the second data packet is the retransmitted data of the first data packet, when combining the retransmitted data and the first data packet, the second device ignores the data information on the preempted resource position of the first data packet based on the first indication information.

Optionally, the first device determines the second indication information based on the demodulation performance parameter and a modulation and coding scheme (MCS).

Specifically, the MCS may correspond to a plurality of thresholds. For example, in the prior art, there are 32 combinations in total for the MCS. Each of the 32 combinations may correspond to one or more thresholds, or a plurality of combinations of the 32 combinations correspond to one threshold, or the like. The first device determines the second indication information based on the demodulation performance parameter and a threshold corresponding to the MCS of the first data packet.

For example, if the demodulation performance parameter is greater than a first threshold corresponding to the MCS, the first device determines that the second indication information is used to indicate that the second data packet is new data.

In other words, if the second indication information is used to indicate that the second data packet is new data, the second device clears a buffer of received data, and stores the second data packet.

It should be noted that in this embodiment of the present invention, the data of the second data packet may be the same as the data of the first data packet. To be specific, the second indication information is used to instruct the second device to clear only the buffer of the received data. However, for the first device, the data of the second data packet may be the data of the first data packet.

For another example, if the demodulation performance parameter is less than the first threshold and greater than a second threshold corresponding to the MCS, the first device determines that the second indication information is used to indicate that the second data packet is the retransmitted data of the first data packet, and the redundancy version of the second data packet is the same as the redundancy version of the first data packet.

For another example, if the demodulation performance parameter is less than the second threshold, the first device determines that the second indication information is used to indicate that the second data packet is the retransmitted data of the first data packet, and the redundancy version of the second data packet is different from the redundancy version of the first data packet. Optionally, redundancy information in the redundancy version of the second data packet is more than redundancy information in the redundancy version of the first data packet, or redundancy information in the redundancy version of the second data packet is less than redundancy information in the redundancy version of the first data packet.

In other words, if the second indication information is used to indicate that the second data packet is the retransmitted data of the first data packet, the second device stores the second data packet in the buffer of the received data based on the second indication information, and performs combined decoding on the second data packet and the first data packet.

In this embodiment of the present invention, the first device may feed back the preempted position to the second device, so that the second device can discard the information on the preempted position by using the information about the preempted position during the data detection and the HARQ combination, thereby improving the detection performance of the second device.

It should be understood that, the first threshold and/or the second threshold in the foregoing descriptions is merely an example for description, and this embodiment of the present invention is not limited thereto.

Optionally, the second indication information includes a new data indicator (NDI) and/or a redundancy version (RV).

Specifically, each HARQ process stores an NDI value. In this value, one bit is used to indicate whether scheduled data is newly transmitted or retransmitted. If an NDI value in a same HARQ process is toggled (NDI toggled) than before, it indicates that a current transmission is an initial transmission of a new data packet; otherwise, (NDI not toggled) indicates that a current transmission is a retransmission of a same data packet.

In other words, when sending a data packet, the first device sets one-bit new data indicator signaling NDI. Each time a new data packet is sent, the NDI is toggled once, and after receiving the toggled NDI, the second device clears the buffer of the received data and stores new data; however, when a data packet is retransmitted, the NDI remains unchanged, and after receiving the unchanged NDI, the second device stores the NDI in the buffer of the received data, and performs combined decoding with an earlier version.

For example, if the NDI is toggled (o is changed to 1, or 1 is changed to 0), it indicates that a new transmission is to be performed this time.

It should be understood that, in this embodiment of the present invention, a specific value of the NDI at each time is not limited, but only whether the value of the NDI is changed is considered.

In this embodiment of the present invention, optionally, the first device accumulates a quantity of retransmissions of the first data packet, the quantity of transmissions is used to determine the first threshold, and the quantity of transmissions of the first data packet is added to the quantity of retransmissions, or the quantity of transmissions of the first data packet is not added to the quantity of retransmissions.

It should be understood that in this embodiment of the present invention, the first device can adaptively adjust the HARQ transmission by evaluating the demodulation performance loss caused by the preemption, thereby improving the spectral efficiency. However, for an actual transmission process, the first device may alternatively be subject to a received ACK/NACK.

For example, the first device determines, by evaluating the demodulation performance loss caused by the preemption, that the second indication information is used to indicate that the second data packet is the retransmitted data of the first data packet. However, the first device also receives feedback information for the first data packet that is sent by the second device, and the feedback information indicates that the first data packet has already been successfully received, so that the first device may re-determine that the second indication information is used to indicate that the second data packet is the new data.

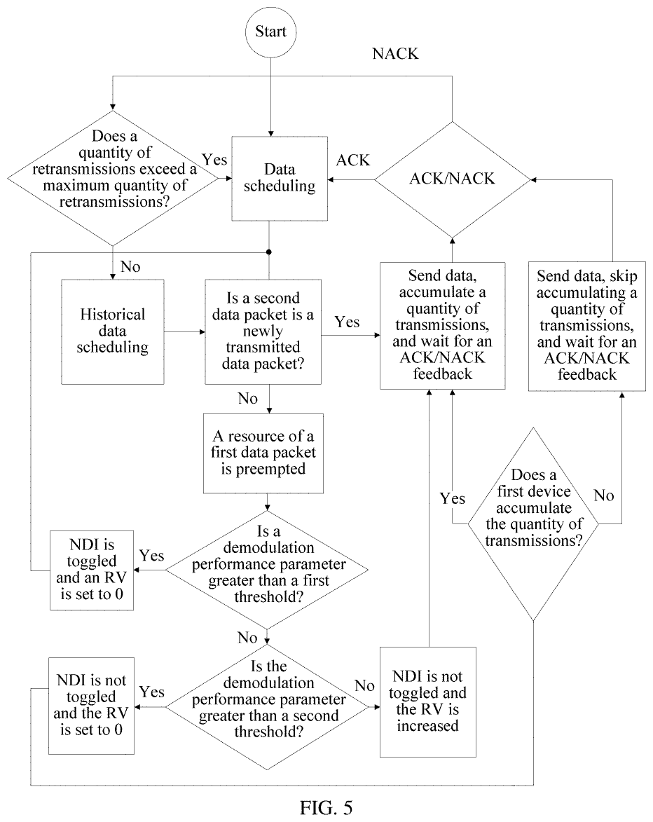

FIG. 5 is another schematic flowchart of a data transmission method according to an embodiment of the present invention.

As shown in FIG. 5, a first device performs data scheduling, and sends a second data packet to a second device.

In an embodiment, if the second data packet is newly transmitted data, the first device accumulates a quantity of transmissions, and waits to receive an ACK/NACK feedback for the second data packet that is sent by the second device.

In another embodiment, if the second data packet is not newly transmitted data, the first device determines second indication information of the second data packet based on a preempted resource of a previously transmitted first data packet and a threshold corresponding to an MCS. Specifically, the first device determines the second indication information based on the preempted resource of the first data packet and the threshold corresponding to the MCS. More specifically, if the demodulation performance parameter is greater than a first threshold, the first device determines that in the second indication information, an NDI is toggled and an RV is set to 0; if the demodulation performance parameter is less than the first threshold and greater than a second threshold, the first device determines that in the second indication information, the NDI is not toggled and the RV remains unchanged; or if the demodulation performance parameter is less than the second threshold, the first device determines that in the second indication information, the NDI is not toggled and the RV is increased. After determining the second indication information, the first device adds the second indication information to the second data packet, and sends the second data packet to the first device.

In this case, the first device may add a quantity of transmissions of the first data packet to the quantity of retransmissions, or the first device may alternatively not add a quantity of transmissions of the first data packet to the quantity of retransmissions. The second device waits to receive the ACK/NACK feedback for the second data packet that is sent by the second device.

Finally, if the first device receives the NACK feedback for the second data packet, the first device performs data scheduling or historical data scheduling again based on a maximum quantity of retransmissions. If the first device receives the ACK feedback for the second data packet, the first device performs data scheduling again.

The data transmission method in the embodiments of the present invention is described above, and devices in the embodiments of the present invention are described below.

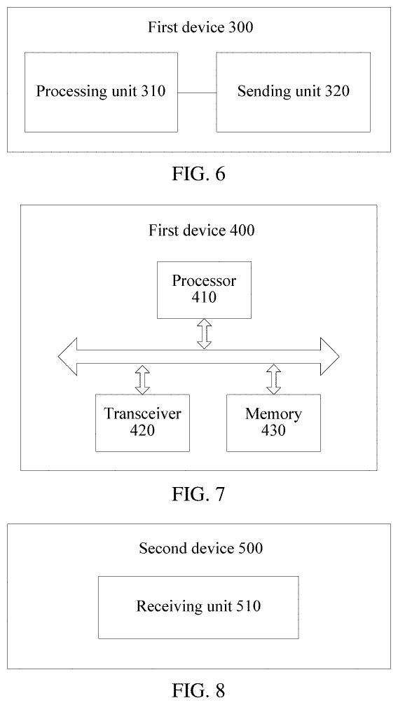

FIG. 6 is a schematic block diagram of a first device 300 according to an embodiment of the present invention.

As shown in FIG. 6, the first device 300 includes: a processing unit 310, configured to: when a resource position of a first data packet is preempted, generate first indication information, where the first indication information is used to indicate information about the preempted resource position of the first data packet; and a sending unit 320, configured to send the first indication information to a second device, so that the second device receives the first data packet based on the first indication information.

Optionally, the processing unit 310 is further configured to: determine, based on information about a preempted resource of the first data packet, a performance parameter of demodulation performed by the second device on the first data packet; determine second indication information based on the demodulation performance parameter, where the second indication information is used to indicate a data type of a second data packet, the second data packet is sent after the first data packet, and data of the first data packet is the same as data of the second data packet; and send the second data packet to the second device, where the second data packet includes the second indication information.

Optionally, the processing unit 310 is specifically configured to: determine the second indication information based on the demodulation performance parameter and a modulation and coding scheme (MCS).

Optionally, the processing unit 310 is specifically configured to: if the demodulation performance parameter is greater than a first threshold corresponding to the MCS, determine that the second indication information is used to indicate that the second data packet is new data; if the demodulation performance parameter is less than the first threshold and greater than a second threshold corresponding to the MCS, determine that the second indication information is used to indicate that the second data packet is retransmitted data of the first data packet, and a redundancy version of the second data packet is the same as a redundancy version of the first data packet; or if the demodulation performance parameter is less than the second threshold, determine that the second indication information is used to indicate that the second data packet is the retransmitted data of the first data packet, and the redundancy version of the second data packet is different from the redundancy version of the first data packet.

Optionally, when the second indication information is used to indicate that the second data packet is the retransmitted data of the first data packet, the processing unit 310 is further configured to: accumulate a quantity of retransmissions of the first data packet, where the quantity of transmissions is used to determine the first threshold, and the quantity of transmissions of the first data packet is added to the quantity of retransmissions, or the quantity of transmissions of the first data packet is not added to the quantity of retransmissions.

Optionally, the sending unit 320 is specifically configured to: send the first data packet to the second device, where the first data packet includes the first indication information; or send the first indication information to the second device after sending the first data packet.

Optionally, the first indication information includes at least one of the following information: preempted time-frequency resource position information, information about a bit position preempted before encoding, and information about a bit position preempted after the encoding.

Optionally, when preempted resources of the first data packet are contiguous, the first indication information includes preempted start position information and preempted end position information.

Optionally, the second indication information includes a new data indicator (NDI) and/or a redundancy version (RV).

It should be noted that in this embodiment of the present invention, the processing unit 310 may be implemented by using a processor, and the transceiver unit 320 may be implemented by using a transceiver. As shown in FIG. 7, a first device 400 may include a processor 410, a transceiver 420, and a memory 430o. The memory 430 may be configured to store indication information, or may be configured to store code, an instruction, and the like that are to be executed by the processor 410. As an example rather than a limitation, the processor 410, the transceiver 420, and the memory 430 communicate with and are connected to each other in a manner such as by using a bus.

FIG. 8 is a schematic block diagram of a first device 500 according to an embodiment of the present invention.

As shown in FIG. 8, the device 500 includes a receiving unit 510, and the receiving unit 510 is configured to: receive first indication information sent by a first device, where the first indication information includes information about a preempted resource position of a first data packet; and receive the first data packet based on the first indication information.

Optionally, the receiving unit 510 is specifically configured to: when detecting the first data packet, ignore data on the preempted resource position of the first data packet based on the first indication information.

Optionally, the receiving unit 510 is further configured to: receive the second indication information sent by the first device, where the second indication information is used to indicate a data type of a second data packet.

Optionally, the second indication information indicates that the second data packet is retransmitted data of the first data packet, and the receiving unit 510 is specifically configured to: when combining the retransmitted data and the first data packet, ignore information about the data on the preempted resource position of the first data packet based on the first indication information.

Optionally, the first indication information includes at least one of the following information: preempted time-frequency resource position information, information about a bit position preempted before encoding, and information about a bit position preempted after the encoding.

Optionally, when preempted resources of the first data packet are contiguous, the first indication information includes preempted start position information and preempted end position information.

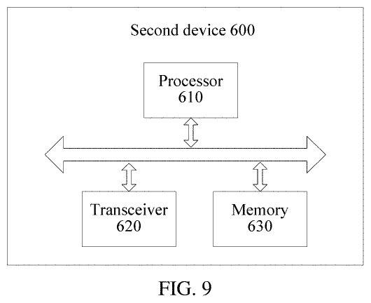

It should be noted that in this embodiment of the present invention, the receiving unit 510 may be implemented by using a transceiver. As shown in FIG. 9, a first device 600 may include a processor 610, a transceiver 620, and a memory 630. The memory 630 may be configured to store indication information, or may be configured to store code, an instruction, and the like that are to be executed by the processor 610. As an example rather than a limitation, the processor 61o, the transceiver 620, and the memory 630 communicate with and are connected to each other in a manner such as by using a bus.

It should be noted that a method performed by the processor in this embodiment of the present invention is the same as content of the foregoing method embodiments, and details are not described herein again. For example, the first device 300 or the first device 400 may perform the method performed by the first device in the foregoing method embodiment, and the second device 500 or the second device 600 may perform the method performed by the second device in the foregoing method embodiment.

It should be noted that the foregoing method embodiments may be applied to a processor or may be implemented by a processor. The processor may be an integrated circuit chip and has a signal processing capability. In an implementation process, the steps in the foregoing method embodiments may be implemented by using an integrated logic circuit of hardware in the processor or an instruction in a form of software. The processor may be a general purpose processor, a digital signal processor (DSP), an application-specific integrated circuit (ASIC), a field programmable gate array (FPGA) or another programmable logic device, a transistor logic device, or a discrete hardware component. All the methods, steps, and logical block diagrams disclosed in the embodiments of the present invention can be implemented or performed by the processor. The general purpose processor may be a microprocessor or the processor may be any conventional processor, or the like. The steps of the methods disclosed in the embodiments of the present invention may be directly performed and completed by a hardware decoding processor, or may be performed and completed by using a combination of hardware and software modules in the decoding processor. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the steps in the foregoing methods in combination with the hardware of the processor.

It can be understood that, the memory in the embodiments of the present invention may be a volatile memory or a non-volatile memory, or may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. As an example rather than a limitation, many forms of RAMs are available, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM). It should be noted that the memory in the system and method described in this specification intends to include but is not limited to these memories and any other appropriate types of memories.

The terms used in the embodiments of the present invention and the appended claims are merely for the purpose of illustrating specific embodiments, and are not intended to limit the embodiments of the present invention.

For example, the term “and/or” in this embodiment of the present invention describes only an association relationship for describing associated objects and represents that three relationships may exist. Specifically, A and/or B may represent the following three cases: Only A exists, both A and B exist, and only B exists. In addition, the character “/” in this specification generally indicates an “or” relationship between the associated objects.

For another example, the terms “a”, “said”, and “the” of singular forms used in the embodiments and the appended claims of the present invention are also intended to include plural forms, unless otherwise specified in the context clearly.

For another example, in the embodiments of the present invention, terms such as first, second, third, and the like may be used to describe various types of devices, indication information, and data packets. However, these devices, indication information, and data packets should not be limited to the terms. These terms are used only to distinguish the devices, indication information, and the data packets.

For another example, depending on the context, for example, words “if” or “as if” used herein may be explained as “while . . . ” or “when . . . ” or “in response to determining” or “in response to detection”. Similarly, depending on the context, phrase “if determining” or “if detecting (a stated condition or event)” may be explained as “when determining” or “in response to determining” or “when detecting (the stated condition or event)” or “in response to detection (the stated condition or event)”.

Persons of ordinary skill in the art may be aware that, the units and algorithm steps in the examples described with reference to the embodiments disclosed in this specification may be implemented by using electronic hardware or a combination of computer software and electronic hardware. Whether the functions are performed by hardware or software depends on particular applications and design constraint conditions of the technical solutions. A person skilled in the art may use a different method to implement the described functions for each particular application, but it should not be considered that the implementation goes beyond the scope of the embodiments of the present invention.

A person skilled in the art may clearly understand that, for the purpose of convenient and brief description, for a detailed working process of the system, apparatus, and unit, refer to a corresponding process in the method embodiments. Details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the embodiments of the present invention.

In addition, each of the function units in embodiments of the present invention may be integrated into a processing unit, or may exist alone physically, or two or more units are integrated into a unit.

When functions are implemented in the form of a software functional unit and sold or used as an independent product, the functions may be stored in a computer-readable storage medium. Based on such an understanding, the technical solutions in the embodiments of the present invention essentially, or the part contributing to the prior art, or some of the technical solutions may be implemented in a form of a software product. The software product is stored in a storage medium, and includes several instructions for instructing a computer device (which may be a personal computer, a server, a network device, or the like) to perform all or some of the steps of the methods described in the embodiments of the present invention. The storage medium includes any medium that can store program code, such as a USB flash drive, a removable hard disk, a memory, a magnetic disk, or an optical disc.

The foregoing descriptions are merely specific implementations of the present invention, but are not intended to limit the protection scope of the present invention. Any variation or replacement readily figured out by persons skilled in the art within the technical scope disclosed in the present invention shall fall within the protection scope of the present invention. Therefore, the protection scope of the embodiments of the present invention shall be subject to the protection scope of the claims.

What is claimed is:

1. A method, comprising:
when a resource position of a first data packet is preempted, generating, by a first device, first indication information, wherein the first indication information indicates information about the preempted resource position of the first data packet; and
sending, by the first device, the first indication information to a second device, causing the second device to receive the first data packet based on the first indication information.

2. The method according to claim 1, further comprising:
determining, by the first device based on information about a preempted resource of the first data packet, a performance parameter of demodulation performed by the second device on the first data packet;
determining, by the first device, second indication information based on the performance parameter, wherein the second indication information indicates a data type of a second data packet, the second data packet is sent after the first data packet, and data of the first data packet is the same as data of the second data packet; and
sending, by the first device, the second data packet to the second device, wherein the second data packet comprises the second indication information.

3. The method according to claim 2, wherein determining, by the first device, second indication information based on the performance parameter comprises:
determining, by the first device, the second indication information based on the performance parameter and a modulation and coding scheme (MCS).

4. The method according to claim 3, wherein determining, by the first device, the second indication information based on the performance parameter and the MCS comprises:
in response to the performance parameter being greater than a first threshold corresponding to the MCS, determining, by the first device, that the second indication information indicates that the second data packet is new data;
in response to the performance parameter being less than the first threshold and greater than a second threshold corresponding to the MCS, determining that the second indication information indicates that the second data packet is retransmitted data of the first data packet, and a redundancy version of the second data packet is the same as a redundancy version of the first data packet; or
in response to the performance parameter being less than the second threshold, determining that the second indication information indicates that the second data packet is the retransmitted data of the first data packet, and the redundancy version of the second data packet is different from the redundancy version of the first data packet.

5. The method according to claim 4, wherein the second indication information indicates that the second data packet is the retransmitted data of the first data packet, and the method further comprises:
accumulating a quantity of retransmissions of the first data packet, wherein the quantity of transmissions is used to determine the first threshold, and the quantity of transmissions of the first data packet is added to the quantity of retransmissions, or the quantity of transmissions of the first data packet is not added to the quantity of retransmissions.

6. The method according to claim 2, wherein the second indication information comprises a new data indicator (NDI) or a redundancy version (RV).

7. The method according to claim 1, wherein sending, by the first device, the first indication information to the second device comprises:
sending, by the first device, the first data packet to the second device, wherein the first data packet comprises the first indication information; or
sending, by the first device, the first indication information to the second device after sending the first data packet.

8. The method according to claim 1, wherein the first indication information comprises:
preempted time-frequency resource position information, information about a bit position preempted before encoding, and information about a bit position preempted after the encoding.

9. The method according to claim 1, wherein when preempted resources of the first data packet are contiguous, the first indication information comprises preempted start position information and preempted end position information.

10. A device, comprising:
a processor; and
a computer-readable storage medium storing a program to be executed by the processor, the program including instructions for:
when a resource position of a first data packet is preempted, generating first indication information, wherein the first indication information indicates information about the preempted resource position of the first data packet; and
a transmitter, configured to:
send the first indication information to a second device, causing the second device to receive the first data packet based on the first indication information.

11. The device according to claim 10, wherein the program further includes instructions for:
determining, based on information about a preempted resource of the first data packet, a performance parameter of demodulation performed by the second device on the first data packet;
determining second indication information based on the performance parameter, wherein the second indication information indicates a data type of a second data packet, the second data packet is sent after the first data packet, and data of the first data packet is the same as data of the second data packet; and
sending the second data packet to the second device, wherein the second data packet comprises the second indication information.

12. The device according to claim 11, wherein the program further includes instructions for:
determining the second indication information based on the performance parameter and a modulation and coding scheme (MCS).

13. The device according to claim 12, wherein the program further includes instructions for:
in response to the performance parameter being greater than a first threshold corresponding to the MCS, determining that the second indication information indicates that the second data packet is new data;
in response to the performance parameter being less than the first threshold and greater than a second threshold corresponding to the MCS, determining that the second indication information indicates that the second data packet is retransmitted data of the first data packet, and a redundancy version of the second data packet is the same as a redundancy version of the first data packet; or
in response to the performance parameter being less than the second threshold, determining that the second indication information indicates that the second data packet is the retransmitted data of the first data packet, and the redundancy version of the second data packet is different from the redundancy version of the first data packet.

14. The device according to claim 13, wherein the second indication information indicates that the second data packet is the retransmitted data of the first data packet, and the program further includes instructions for:
accumulating a quantity of retransmissions of the first data packet, wherein the quantity of transmissions is used to determine the first threshold, and the quantity of transmissions of the first data packet is added to the quantity of retransmissions, or the quantity of transmissions of the first data packet is not added to the quantity of retransmissions.

15. A device, comprising:
a receiver, configured to:
receive first indication information sent by a first device, wherein the first indication information comprises information about a preempted resource position of a first data packet; and
receive the first data packet based on the first indication information.

16. The device according to claim 15, wherein the receiver is configured to:
in response to detecting the first data packet, ignore data on the preempted resource position of the first data packet based on the first indication information.

17. The device according to claim 15, wherein the receiver is further configured to:
receive second indication information sent by the first device, wherein the second indication information indicates a data type of a second data packet.

18. The device according to claim 17, wherein the second indication information indicates that the second data packet is retransmitted data of the first data packet, and the receiver is configured to:
in response to combining the retransmitted data and the first data packet, ignore information about data on the preempted resource position of the first data packet based on the first indication information.

19. The device according to claim 15, wherein the first indication information comprises:
preempted time-frequency resource position information, information about a bit position preempted before encoding, or information about a bit position preempted after the encoding.

20. The device according to claim 19, wherein preempted resources of the first data packet are contiguous, and the first indication information comprises preempted start position information and preempted end position information.
